(19) United States
(12) Patent Application Publication
(10) Pub. No.: US 2014/0140466 A1
(43) Pub. Date: May 22, 2014

(54) Semi Submersible Nuclear Power Plant and Multipurpose Platform

(71) Applicant: David W. Richardson, Solana Beach, CA (US)

(72) Inventor: David W. Richardson, Solana Beach, CA (US)

(21) Appl. No.: 13/540,438

(22) Filed: Jul. 2, 2012

(51) Int. Cl. G21D 1/00

(52) U.S. Cl. CPC G21D 1/00
USPC 376/317

(57) ABSTRACT

Disclosed is an offshore, manned, scalable, modular, floating, moored, nuclear power generating plant and multipurpose platform. The present invention is comprised of a Main Plant Control Deck, Central Plant Deck, and submerged Reactor-Generator Deck(s) integrated into the structure of a Spar or Cell Spar Platform. The Reactor-Generator decks are comprised of a plurality of modular, Naval Nuclear Pressurized Water Reactor Modules. Electricity generated is transmitted via submarine High Voltage Direct Current Cables to shore. Ancillary, co-generated services, e.g. desalinated water, are transmitted to shore via submarine pipelines. Multipurpose Topside Decks house vessel command, crew, and any ancillary and co-generation equipment. The present invention, constructed in a multi-path manufacturing process, provides exceptional economic, environmental, sustainability, security, safety, and operational advantages over the current art of power generation.

### CROSS-REFERENCE TO RELATED APPLICATIONS

Not applicable

### REFERENCES CITED

U.S. Patent Documents:

| | | |
|---|---|---|
| 3,837,308 | September 1974 | Harvey et al. |
| 3,962,877 | June 1976 | Schiemichen |
| 4,302,291 | November 1981 | Severs et al. |
| 4,919,882 | April 1990 | Aul et al. |
| 5,247,553 | September 1993 | Herring |
| 7,978,806 | July 2011 | Hayman III |
| US 2009/0256421 A1 | October 2009 | Chung |
| US 2011/0158370 A1 | June 2011 | Morgan |

Non-Patent Literature:

(No author listed), “Nuclear Power in Russia,” online trade news source, World Nuclear News 5/2012

(No author listed), “MH-1A”, online free encyclopedia, Wikipedia 5/2012

### STATEMENT REGARDING FEDERALLY SPONSORED RESEARCH OR DEVELOPMENT

Not Applicable

### BACKGROUND OF THE INVENTION

1. Field of Invention

The present invention relates to nuclear power plants and more specifically to an offshore, floating, moored, nuclear power generating plant, integrated into the submerged hull of a spar or cell spar platform.

2. Description of Prior Art

There is unequivocal evidence that man made contributions to global warming through increased emissions of heat and greenhouse gases from various forms of carbon fuel combustion, can and must be eliminated to allow our ecosystem to sustainably continue to provide a habitable environment. This fact, combined with rapidly diminishing hydrocarbon reserves and constantly escalating fuel costs, has ignited a growing global effort to shift to a sustainable, renewable energy powered future. There is global consensus among energy experts that, in order to make the required leap from the current unsustainable energy status quo, a new generating technology is required to provide a bridge to a sustainable, all renewable energy powered future.

Nuclear energy has traditionally shown the most promise for affordable, clean, reliable power. All commercial nuclear power plants in the U.S. are currently sighted on land, most on residentially valuable coastal, river, or lake shores for access to cooling water. Sighting nuclear power plants on coastal locations results in the installations being vulnerable to seismic events, cyclones and tsunami, thereby escalating the costs of construction and operation. The majority of said power plants are also surrounded by high density population centers escalating land and water prices and a growing public resistance to land based nuclear power. These issues have traditionally been the impetus to design a sustainable, affordable offshore nuclear power plant. The principle public, regulatory, and industry concerns regarding land based nuclear power plants include:

1. Protection from operational nuclear accidents.
2. Protection from nuclear accidents generated by natural calamities.
3. Protection from terrorist attacks on nuclear power plants neighboring populated areas.
4. Environmental contamination protection from nuclear power plant operations.
5. Competition with population needs for water resources.
6. Large high value land requirements.
7. Expensive, lengthy construction and commissioning times, escalating ratepayer costs.
8. Nuclear fuel consumption and resultant waste proliferation.
9. Stolen nuclear fuel facilitating illicit nuclear weapons proliferation.
10. Safety and reliability of existing nuclear plants operating past original license term.

In addition to the above concerns, the power generating industry must constantly balance the electrical supply to randomly fluctuating demand, often requiring rapid adjustments to meet unpredictable occurrences affecting the grid. After the Fukushima, Japan disaster on Mar. 11, 2011, the public increased their volume of dissent. Government regulatory agencies and power plant owners are attempting to address these issues for land based nuclear facilities, but the public is justifiably wary. Japan has currently shut down all nuclear power plants for maintenance and upgrading, and will use the 2012 peak summer season demand to evaluate permanent abandonment of nuclear power for electricity generation. The United States is currently promoting and subsidizing the design and implementation of next generation land based reactors, emphasizing small, modular designs in an attempt to address these concerns.

The prior art of offshore nuclear power plants fall into three categories: fixed, floating, and submersible. Of the floating concepts and patents, the first, in the 1960's, was the Sturgis, a retired U.S. Navy vessel that was gutted and fitted with a MH1 nuclear generating plant. It provided power for the U.S. Army installation at Lake Gatun, Panama and although successful, It did not generate commercial interest, and was retired.

In May 2012, World Nuclear News reported that Russia is building a fleet of floating nuclear power plants, which employ their icebreaker nuclear power plants, to be deployed to support mining and hydrocarbon processing in the arctic. Resembling cruise ships, the vessels are vulnerable in adverse weather and turbulent sea surface conditions.

U.S. Pat. No. 3,837,308 describes an offshore floating power plant comprised of a double walled spherical shell containing a nuclear reactor powering multiple generators, to produce and export electricity. The invention floats on the surface, anchored to sea floor, and incorporates a unique counter-balance mechanism to mitigate the wave motion on the plant. The costly unproven, complex design was never constructed.

U.S. Pat. No. 3,962,877 describes a fixed offshore power plant encompassing gas or petroleum fired turbines and steam generators encased in the support structure. The support structure extends legs to the seafloor positioning all equipment above the surface of the sea. This design fails to address vulnerabilities to cyclones, tsunami, seismic events, and carbon emission proliferation.

U.S. Pat. No. 4,302,291 describes an underwater nuclear power generating plant comprising a triangular platform formed by tubular legs supporting large spherical pressure vessels and smaller cylindrical auxiliary pressure vessels. The device requires the operators to remain submerged for extended periods and crew and materials transfer would be by submarine rendering it financially unattractive and logistically impractical.

U.S. Pat. No. 4,919,882 describes a modularized nuclear steam supply system installed on a barge and floated to it's coffer dam site, which is representative of a plurality of surface floating power plant designs, each having the same advantages in construction cost and time savings, and importantly, sharing the same catastrophic disadvantages: seismic, tsunami, and cyclone vulnerabilities, public exposure to operational, terrorist and natural calamity caused nuclear accidents, as well as contributing to nuclear proliferation, nuclear environmental impacts, and resource competition with the public.

U.S. Patent Application Publication US 2009/0256421 A1 describes a nuclear steam system similar to U.S. Pat. No. 4,919,882, except that it is self propelled. 2009/0266421 fails for the same reasons as U.S. Pat. No. 4,919,882 et al.

U.S. Pat. No. 5,247,553 describes an unmanned “submerged passively safe power station” capable of generating at least 600 MWe utilizing a pressurized water reactor. These power stations are submarine drones which are completely self contained and operated remotely. The stations are guided into position and tethered above the seafloor. The invention was intended to provide temporary power to aid developing countries with little or no infrastructure and for use in an emergency response to a catastrophe. This technology has some safety limitations, would be prohibitively expensive, and to date not been built.

U.S. Patent Application 2011/0158370 A1 describes an offshore, floating, moored nuclear powered energy carrier plant. The invention proposes using a naval nuclear reactor generator to provide power to hydrocarbon refinement process equipment installed on a standard semisubmersible offshore oil rig. The inventor specifies that the plant does not export power to the grid, and is inoperable in stormy ocean conditions.

U.S. Pat. No. 7,978,806 describes an un-manned Seafloor Power Station. The reactor generator units are installed in a geodesic sphere which floats submerged, and is tethered with cables to a gravity mat located on the ocean floor. The sphere is raised and lowered by winches for maintenance and refueling. All of the operations of the station are controlled remotely from an onshore base. The invention fails to address nuclear fuel consumption and waste proliferation, and cost effectiveness.

### BRIEF SUMMARY OF THE INVENTION

According to various aspects of the present invention, a nuclear power plant is integrated into the submerged hull of an offshore, floating Spar or Cell Spar Platform. The invention as presented, employs the same type platform as currently used in the hydrocarbon industry to drill and extract oil and gas at offshore locations. The spar and cell spar platforms have proven to be the safest, most reliable, cost effective and stable offshore floating structures. The present invention incorporates existing technologies from a plurality of internationally competitive manufacturers ensuring high quality, competitive pricing, and rapid construction time. The scale and design of each embodiment is task specific, relative to the amount of electricity required, location, and ancillary services provided. The current art of spar and cell spar platform construction has matured to a highly efficient, assembly line process, that has reduced a comparably sized oil services spar rig construction time to less than three (3) years.

The Reactor-Generator Secondary Containment Modules are also assembly line constructed and transported to the spar assembly area. In the preferred embodiment, the Reactor-Generator Decks, the Main Control Deck, and the Central Plant Deck all interlock to become the submerged “Dry Tank”, which is integrated into the structure of the Ballast Hull. Submerging the Reactor-Generator Decks results in significant weight displacement of the heaviest decks, increased platform stability, increased Topside Decks capacity, and increased reactor thermal efficiency due to the external cold water. The Reactor-Generator Decks contain all the Reactor-Generator Modules and any equipment necessary to produce and export electricity. In the preferred embodiment, the Modules are arranged in a radial configuration around a central elevator shaft/mechanical chase, maximizing space efficiency and facilitating operations with the minimum personnel necessary for safety and efficiency. In the preferred embodiment each Reactor-Generator Module employs an A4W/G, the new A1B, or other compact naval pressurized water reactor. Each module is a complete power source capable of operating independently and collectively through steam piping configurations, that interconnect all modules, common practice to anyone familiar with the art. The compact naval reactor-generators are specifically designed for hazardous sea duty, to fit into restricted space, and operate at full power for 20 to 50 years, model dependent, before onsite refueling. In the preferred embodiment, twenty (20) A4W/G Reactor-Generator Modules were assumed, exceeding 20 year core life, and producing approximately 2100 MW.

The design of the Topside Decks is task-specific, and houses crew, platform command, ancillary cogeneration equipment, and all regulatory and security personnel and equipment. The platform makes it's own fresh water and “make-up” water for the steam generators from desalination, and treats it's waste. The platform command would be equipped with current state of the art sonar and other threat detection equipment. There is a helipad and crane to enable crew, supplies, and equipment to be easily transferred to the platform. The Hull would be maintained by submersible equipment.

The present invention, as with all spar platforms, is designed to remain in place and operational regardless of the severe environmental conditions during cyclones and tsunami, while adjustable mooring systems insulate the platform from any seismic events. The platform would typically be moored within 20 kilometers from shore, facilitating crew and supplies exchanges without requiring overnight accommodations for the personnel. The present invention is constructed and installed in the same manner as oil rig spar platforms i.e., the ballast hull, topside decks and dry tank components are constructed separately, floated and towed to the location, assembled and moored. The HVDC cables for electrical transmission and submarine piping for conveyance of any ancillary cogeneration services, would have been installed concurrently.

Accordingly, mindful of the failings of the prior art, and the immediacy of the need to develop an affordable, sustainable, carbon free means of power generation, a first object of the present invention is to provide an offshore, semi submersible, floating, moored, modular, nuclear power plant and multipurpose platform.

A second object of the present invention is to provide a method of construction which maximizes time and cost savings by employing standardized, modularized assembly of the constituent parts on parallel construction pathways, that is achieved by simply employing existing oil rig, and reactor-generator module construction methods and manufacturers, who have reduced the construction and deployment time of comparably sized oil rigs and Navy nuclear modules to less than three years.

A third object of the present invention is to provide said power plant in a manner which minimizes or eliminates the threat of contamination or injury to the general public from operational accidents, that is accomplished by locating the power plant offshore, away from any population, employing naval reactors which have a perfect safety history, and submerging the power plant in cold water, preventing catastrophic melt downs.

A fourth object of the present invention is to protect the public and the power plant from damage and contamination from effects of natural calamities, specifically seismic events, tsunami, and cyclones, that is accomplished by employing the spar or cell spar platform design, proven to insulate the platform from seismic events, tsunami, and cyclones when the present invention is deployed offshore, permitting safe, uninterrupted operations.

A fifth object of the present invention is to protect the public and power plant from damage and contamination resulting from a successful terrorist attack, again achieved by deploying offshore and having a “Fail Safe” capability, which diminishes it's target value and provides a clear line of sight of any potential surface terrorist threat. In addition to the safety of isolation, the platform employs the latest naval threat detection technology to prevent a stealth terrorist attack, and can ascend, submerge, and maneuver to inhibit boarding.

A sixth object of the present invention is to prevent any environmental degradation or contamination resulting from power plant operations or location, that is achieved by maintaining a closed loop cooling water system, isolating any radioactive water from contact with the seawater. Further, the seawater used in the cooling cycle is returned to the environment at a matching ambient seawater temperature. Additionally, to avoid environmental contamination the submerged hull will not be applied with environmentally deleterious antifouling coatings and will be maintained using small submersibles.

A seventh object of the present invention is to eliminate competition with the public for scarce natural resources, specifically potable water and land, that is again, achieved by locating the power plant offshore, minimizing land needs and immersing the power plant in unlimited cooling water, eliminating any competition with the public for said resources.

An eighth object of the present invention is to minimize consumption of nuclear fuel and contributions to nuclear waste repositories, while preventing terrorist acquisition of nuclear material, that is achieved through use of naval nuclear reactors, which require onsite fuel rod exchange only after 20 to 50 years, model dependent, greatly reducing nuclear waste contributions and eliminating the need to maintain an onsite nuclear waste storage facility, removing the attraction to terrorists to steal fuel.

A ninth object of the present invention is to provide a means to efficiently balance the fluctuations in electrical supply/demand, which is achieved by utilizing multiple modular naval nuclear reactors which are designed for rapid adjustments. Additionally, by deploying a fleet of the present invention, a stable but highly adjustable baseline supply network would be created, capable of mitigating disruptive fluctuations in power supply and demand quickly and efficiently, complementing less predictable and responsive renewable power sources such as wind and solar.

A tenth object of the present invention is to avoid the vulnerability of all single reactor nuclear power plant designs to relatively minor component and materials failures causing service interruptions, and provide a power plant minimally affected by said failures or required maintenance, that is achieved by utilizing multiple compact, modular, naval nuclear reactor-generators, that are interconnected through standard steam piping design, facilitating isolation of any failed component(s), allowing all unaffected reactor-generators continued operation, adjusting to mitigate the reduced power contribution, and facilitating repairs without service interruption.

An eleventh object of the present invention is to provide a means to supply ancillary cogeneration services such as; desalinated potable water, hydrogen extraction, and HVAC steam and cooling water for shore based demands, that is achieved by integrating the power generating decks into the submerged hull of the platform, freeing the topside structure to house the required cogeneration equipment, and by diverting steam and electricity from the reactor-generators to the cogeneration equipment as required.

A twelfth object of the present invention is to produce a sustainable, alternative power generation technology, that is economically competitive with unsubsidized carbon emitting power generation, including natural gas, thereby providing a means to create a “bridge” to sustainable, all renewable energy generation, that is achieved by the deployment of a fleet of the present invention, which have overnight construction costs and operating expenses, including decommissioning, lower than natural gas fired power plants not including fuel cost, providing clear economic incentive to phase out all carbon emitting power plants, as well as existing, aging land based nuclear power plants.

To achieve the foregoing and other objects, and in accordance with the purpose of the present invention as embodied and broadly described herein, the present invention may comprise; a scalable, modular, nuclear power plant integrated into the submerged structure of a spar, cell spar platform, or other similar semi submersible design, comprised of at least one; topside structure, main control deck, central plant deck and submerged reactor-generator deck, said deck containing multiple naval nuclear reactor-generator modules, capable of generating electricity and steam for export, and cogeneration services.

### BRIEF DESCRIPTION OF THE SEVERAL DRAWINGS

The accompanying drawings, which are incorporated herein and form a part of the specification, illustrate embodiments of the present invention and combined with the description, serve to explain the principles of the invention. In the drawings:

FIG. 1 depicts an elevation view of a spar platform embodiment of the present invention.

FIG. 2 depicts a plan view of a typical reactor-generator deck of a spar platform embodiment of the present invention.

FIG. 2a is a detail inset depicting the general operating diagram of the power generating process employed in the present invention, identifying the direction of flow of the steam and cooling loops and major equipment components, figuratively arranged, in a spar platform embodiment of the present invention.

FIG. 3 depicts an elevation view of a cell spar embodiment of the present invention.

FIG. 4 depicts a plan view of a typical reactor-generator deck of a cell spar embodiment of the present invention.

FIG. 4a is a detail inset depicting the operating diagram of the power generating process employed in the present invention, identifying the flow of the steam and cooling loops and major equipment components figuratively arranged, in cell spar embodiment of the present invention.

### DETAILED DESCRIPTION OF THE INVENTION

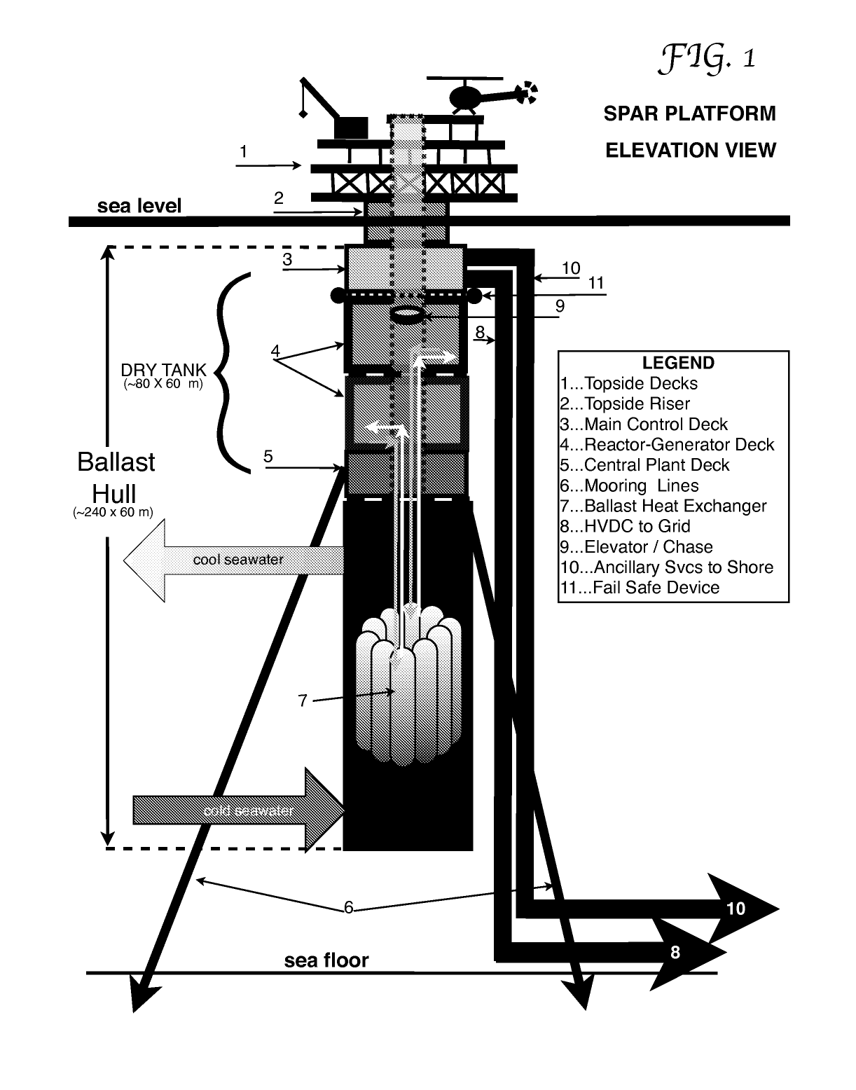

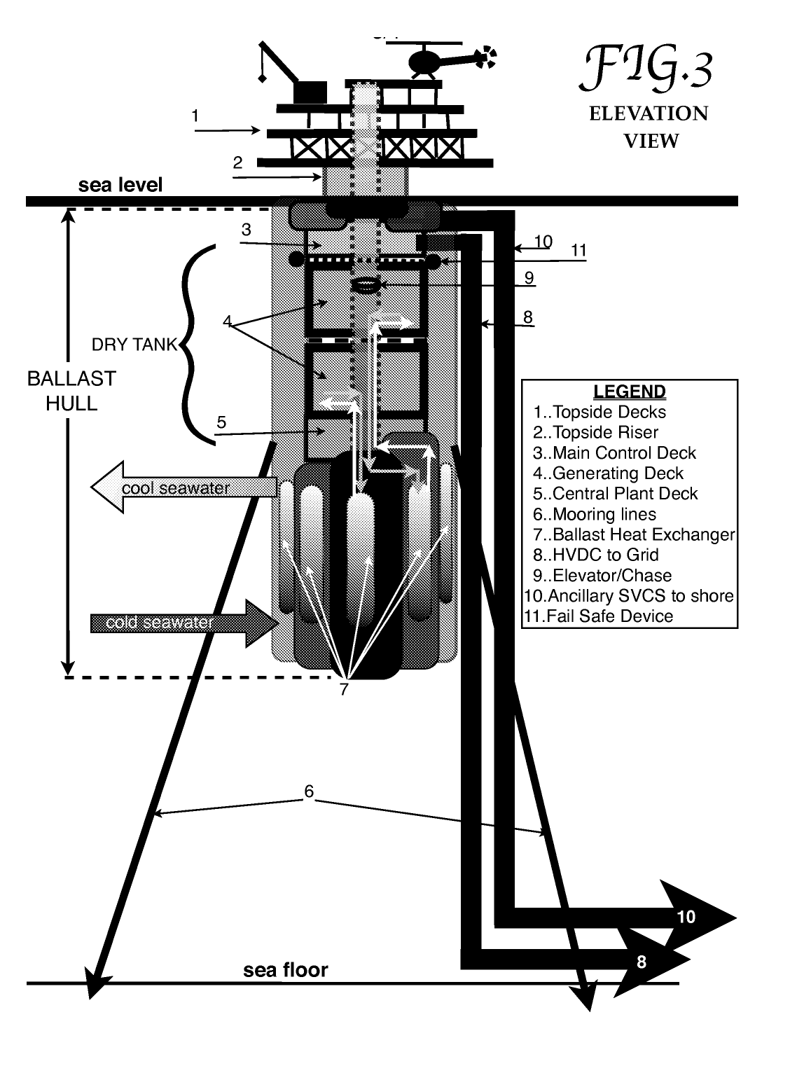

Referring to the drawings, FIG. 1 and FIG. 3 are elevation views of a spar and cell spar platform embodiments respectively, of the present invention. In both drawings, the present invention is comprised of a Topside Deck (1) structure, a cylindrical connecting Riser (2), and the submerged Dry Tank containing the Main Control Deck (3), two Reactor-Generator Decks (4), one Central Plant Deck (5), and the Ballast Hull containing the cooling Heat Exchangers (7). The scale of the embodiments is similar to the scale of the “Holstein” and “Perdido” spar platforms. The Platform overall length is roughly 270 m, with the submerged portion of the spar platform embodiment approximately 240 m long and 60 m in diameter, and the dry tank assembly accounting for 80 m of the overall submerged length.

Again, referring to the drawings FIGS. 1 and 3, the Topside Decks (1) are task-specific designed to address a myriad of potential requirements, accommodate any ancillary cogeneration services provided, as well as house all platform command, personnel, and controls, independent regulatory personnel and equipment, and any ancillary research labs, personnel, and equipment. The design of the Topside Decks (1) permits “all weather” operability. There is a helipad and crane facilitating the transfer of personnel, equipment and supplies. There is a Mechanical Chase (9) connecting the helipad to the Central Plant Deck (5) housing an elevator and all piping and conduits. The Topside Riser (2) connects the Topside Decks (1) to the Main Control Deck (3).

Again, referring to FIGS. 1 and 3, the “Dry Tank” assembly is comprised of a Main Control Deck (3), two (2) Reactor-Generator Decks (4), and a Central Plant Deck (5). The Main Control Deck (3) houses all the equipment and personnel necessary to operate a power plant of comparable size. The Main Control Deck (3) is connected to the Reactor-Generator Deck (4) below, through a Fail Safe Device (11), which permits a quick disconnection of the Reactor-Generator Deck (4) in the event of catastrophic failure or immanent terrorist threat. The fail safe sequence shuts down the reactors, initiates evacuation, and disconnects from the Main Control Deck (3), allowing the hull to be submerged for subsequent retrieval, flooding the Secondary Shield Containment Modules for safety, if needed. The Reactor-Generator Decks (4) contain all the Reactor-Generator Modules, which are comprised of equipment contained in the Secondary Shield Sub Module and the unshielded equipment areas of the module. There are ten (10) A4W/G Reactor-Generator Modules employed per deck in the preferred embodiment, yielding approximately 2100 MW. Connected directly under the Reactor-Generator Decks (4), is the Central Plant Deck (5), containing all the equipment necessary to support a platform of this size and complement. The Central Plant Deck (5) also provides an access chamber to the interior of the Ballast/Heat Exchanger (7) portion of the Hull. The Ballast/Heat Exchanger (7) section of the hull contains, among other miscellaneous equipment, the fixed ballast, buoyancy devices, and the seawater cooled Heat Exchangers (7). In FIG. 1 said section is directly under the “Dry Tank” assembly, while in FIG. 3, the ballast, Heat Exchangers (7) et al, are provided in the cylindrical cells surrounding the “Dry Tank” assembly. Said cells also serve as storage tanks for fluids generated by any of the ancillary cogeneration services provided. The cooling seawater circulating through the Heat Exchangers (7) never comes into direct contact with radioactive sources, and the effluent is thermally modulated to blend harmlessly with the surrounding environment, eliminating any thermal environmental pollution. There are two (2) Mooring Lines (6) depicted, representing the plurality of adjustable tension mooring lines attached to permanent anchors. All decks are aligned so that the Elevator/Mechanical Chase (9) has unencumbered range through all decks from the deck of the helipad to the base of the Central Plant Deck (5). There are two pairs of directional lines, each with one white, one gray line, representing the cooling water piping between the Ballast Heat Exchangers (7) and the steam condensers located in each of the modules on the Reactor-Generator Decks (4). There are two bold directional lines (8 & 10) representing the plurality of submarine HVDC cables and pipelines facilitating the transfer of electricity through a transformer to the grid, and cogeneration services to shore.

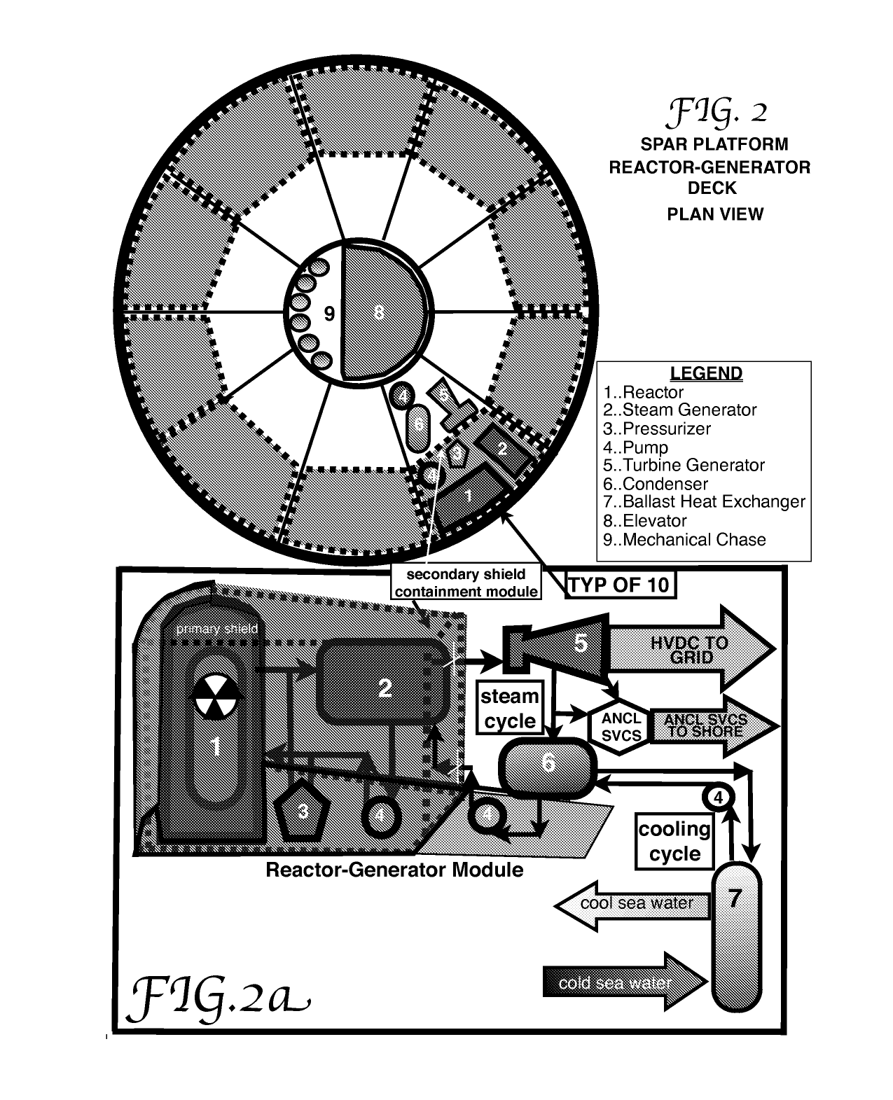

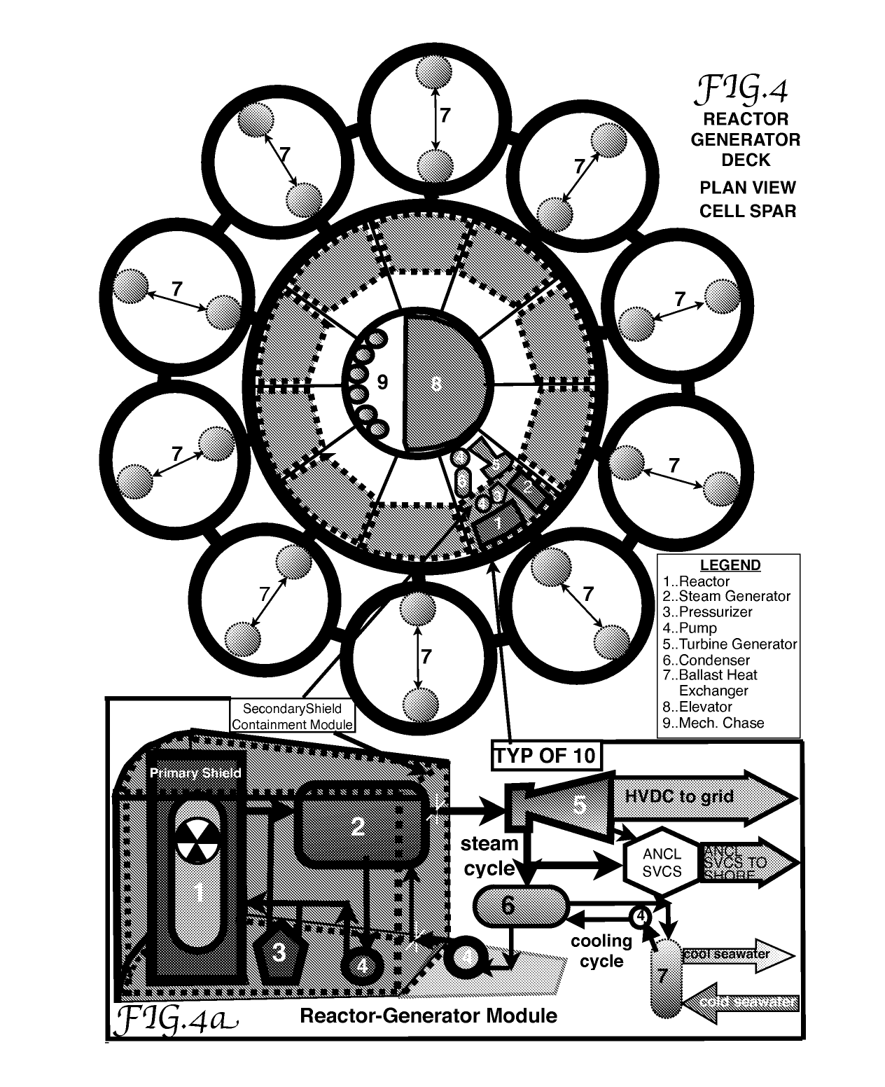

FIGS. 2 and 4 depict plan views of the Reactor-Generator Deck (4) of a spar and cell spar embodiments respectively, and as with the elevation views in FIGS. 1 and 3, they are identical except that the Cell Spar (FIG. 4) embodiment depicts the Ballast Cylinders/Heat Exchangers (7) surrounding and attached to the Dry Tank Assembly. Inset FIGS. 2a and 4a, again are identical process flow diagrams depicting a pressurized water reactor and the typical steam and cooling loops and the associated components which are figuratively represented and numbered to coordinate with the components depicted in FIGS. 2 and 4 respectively.

Again referring to FIGS. 2 and 4, depicted is a solid circular line representing the “Dry Tank” perimeter, encircling ten wedges representing the ten (10) operating envelopes per deck of the Reactor-Generator Modules, in the preferred embodiments. There would be no physical divisions between unshielded portions of each module. Within each Module, is a Secondary Shield Containment Submodule represented by a shaded dotted line. Said submodule is constructed and assembled at a factory and shipped to the spar platform manufacturer and welded into place to complete the Module. The Secondary Shield Containment Submodules are similar in design and assembly process as submodules used in U.S. Navy nuclear vessels, and are supplied by the same manufacturers, or those meeting the same certifying criteria. Said Modules in the preferred embodiment are arranged radially, surrounding a central Elevator Shaft/Mechanical Chase (9), maximizing space utilization and reducing the number of personnel required for safe operation. Said Chase (9) contains the Central Elevator (8), and is also the common conduit between the Central Plant Deck (5) and the helipad for all cooling piping, electrical conduit, and any other mechanical equipment, represented as a series of circles in said Chase (9).

The foregoing has described particular embodiments of the novel concepts of the present invention. It is the nature of the art that variations of embodiments are created to meet particular requirements including, but not limited to; electrical demand, environmental location, and ancillary services provided. It will be readily apparent to all basically familiar with the art, and as previously stated herein, that other equivalent embodiments and variations of said embodiments may be effected, without departing from the scope of this invention. For example, various reactor/steam generator configurations, including multiple reactors within a common secondary containment, driving multiple turbine generators and other known items, may be used in the Reactor-Generator Decks (4) of the present invention in place of the individual reactor-generators depicted in each of the Secondary Shield Containment Modules.

The embodiments of the present invention, as broadly described in the specification and depicted in the drawings herein, in which exclusive property or privilege is claimed are defined as follows:

1. An offshore floating, moored, nuclear power generating plant, with a plurality of compact naval nuclear reactor-generators for operation, and integrated within submerged hull of a spar, cell spar, or similar semi submersible platform, buoyantly suspended in a large body of water, comprising:
At least one (1) watertight deck housing all control room equipment required to operate a nuclear power plant employing a plurality of reactor-generators,
At least one watertight deck housing required platform support mechanical equipment,
At least one (1) elevator shaft/mechanical chase,
At least one (1) submerged watertight deck containing a plurality of naval nuclear reactor-generator modules,
said modules comprised of one (1) secondary shield containment submodule, and one (1) unshielded submodule,
said secondary shield containment submodule comprised of at least one shielded nuclear pressurized water reactor, one steam generator, one pressurizer, one circulating pump, and any ancillary equipment and piping customarily employed in secondary shield containment modules installed in naval nuclear powered vessels, and said unshielded submodules comprised of at least one turbine generator, one steam condenser, two (2) circulating pumps, and any ancillary equipment and piping customarily employed in naval nuclear power plants installed in naval nuclear vessels.

2. Any and all spar, cell spar, or similar offshore platform rigs, incorporating a plurality of nuclear reactor-generators in the submerged portion of the structure of said rigs to produce electricity for export.
